(19) United States
(12) Patent Application Publication
(10) Pub. No.: US 2015/0152826 A1
(43) Pub. Date: Jun. 4, 2015

(54) TAPPET

(71) Applicant: Schaeffler Technologies GmbH & Co. KG, Herzogenaurach (DE)

(72) Inventors: Stefan Dorn, Hollfeld (DE); Norbert Geyer, Hochstadt (DE)

(73) Assignee: Schaeffler Technologies GmbH & Co. KG, Herzogenaurach (DE)

(21) Appl. No.: 14/409,740

(22) PCT Filed: May 23, 2013
(86) PCT No.: PCT/EP2013/060603

§ 371 Date: Dec. 19, 2014

(30) Foreign Application Priority Data
Jun. 28, 2012 (DE) 10 2012 211 113.1

(51) Int. Cl. F02M 59/10; F16H 53/06

(52) U.S. Cl. CPC F02M 59/102; F16H 53/06

(57) ABSTRACT

A tappet (1) for a high-pressure fuel pump of an internal combustion engine is provided, having a tube-like housing (2), in the case of the drive-side annular face (3) of which two flat sections (5) are indented from an outer lateral surface (4) of the housing (2) lying diametrically opposite one another, in which flats a pin (7) is mounted which supports a roller (6), wherein, axially below the roller (6), an inner lateral surface (8) of the housing (2) is penetrated by a separate bridge piece (9), a driven-side end face (10) of which acts as a rest for a tappet follower part and which bears axially firstly in the direction of the drive-side annular face (3) against undersides (13) of the flat sections (5) and secondly in the direction of an output-side annular face (11) of the housing (2) by way of a securing ring (12) which is fixed on the inner shell (8), wherein the bridge piece (9) is held by the securing ring (12) such that it is clamped axially and radially without play in the housing (2).

### BACKGROUND

The invention relates to a tappet, in particular, for a pump or a compressor, with a tube-like housing, with two flat sections indented from an outer lateral surface of the housing lying diametrically opposite each other in the drive-side annular end face of this housing, wherein a pin carrying a roller is supported in these flat sections, with a separate bridge piece passing through an inner lateral surface of the housing, axially underneath the roller, wherein the driven-side end face acts as a contact surface for a tappet follower and is contacted axially on one side in the direction toward the drive-side annular end face on bottom sides of the flat sections and also, on the other side, in the direction toward a driven-side annular end face of the housing by a securing ring fixed on the inner lateral surface.

Such a tappet, here for loading a pump piston of a high-pressure fuel pump of an internal combustion engine, is disclosed in DE 10 2006 057 246 A1, FIG. 1A-1C. Its bridge piece can move slightly in the axial and radial directions, which can lead to undesired noise emissions, stated simply, to rattling. It is also specified that the disk-like bridge piece is comparatively thin and thus might no longer be able to handle the high loads of today's high-pressure fuel pumps. A significantly thicker bridge piece, however, cannot be installed. In addition, the bridge piece nearly filling up the tappet in the radial direction allows only a relatively poor passage of media, e.g., diesel oil for the use of the tappet in a high-pressure fuel pump of a quality-regulated internal combustion engine.

### SUMMARY

The goal of the invention is therefore to create a tappet as mentioned above that works with low noise output and can handle high loads.

According to the invention, this goal is attained in that the bridge piece is held clamped in the housing by the securing ring without play in the axial and radial directions.

This arrangement provides a tappet without the disadvantages named above. The bridge piece is clamped in a comparatively simple way in the radial and axial directions by means of the snap ring. Here it is especially preferred if, as already proposed, for forming the radial clamping between the bridge piece and the inner lateral surface of the housing, snap ends of the securing ring are bent in the axial direction of the tappet and have a hook-like profile, spreading out away from each other. Separate wedges or the like are also conceivable, however.

In particular, if the bridge piece is a beam, as provided in a refinement of the invention, the snap ends ultimately act in a lens-shaped or circular section-shaped gap and clamp the bridge piece-housing system to each other, especially in the radial direction. Existing play is easily compensated.

If the, e.g., punched bridge piece has a beam-like shape, this can be installed in a comparatively easy way through inclined placement and insertion and can be provided with an increased height. A comparatively large volumetric flow of, e.g., diesel fuel/lubricant is possible laterally along the bridge piece.

Simple measures of an axial mounting of the securing ring are the subject matter of another subordinate claim. Consequently, the securing ring can sit either on retaining projections extending from the inner lateral surface of the housing or in an annular groove in the inner lateral surface of the housing. In the case of the retaining projections, it is preferred to form these e.g., a) as extensions/passed-through material going out from the outer lateral surface of the housing, b) as attachments to the inner lateral surface of the housing, or c) as welded or soldered points on the inner lateral surface of the housing or the like.

In another realization of the invention, the retaining projections can be formed as snap tabs or can have a snap tab-like construction, with the snap ring contacting the roof-like top sides of these projections.

As the snap ring, e.g., a standardized axial securing element, such as a round wire circlip, is envisioned whose snap ends are only slightly angled away at a later time. However, a plurality of other open ring shapes, also non-standardized rings, could be used.

The tappet according to the proposal should be used for at least indirect loading of a pump piston of a fuel injection pump of a quality-regulated or quantity-regulated internal combustion engine. At the same time, it could be used in a valve train of an internal combustion engine or in an axial or radial piston compressor or a respective pump.

### BRIEF DESCRIPTION OF THE DRAWINGS

The invention will be explained with reference to the drawings.

FIG. 1 shows a three-dimensional view of the tappet;

FIG. 2 shows the snap ring as a detail;

FIG. 3 shows the tappet in longitudinal section along the beam-shaped bridge piece;

FIG. 4 shows a longitudinal section turned by 90° relative to FIG. 3, and

FIG. 5 shows a bottom view of the tappet according to FIG. 4.

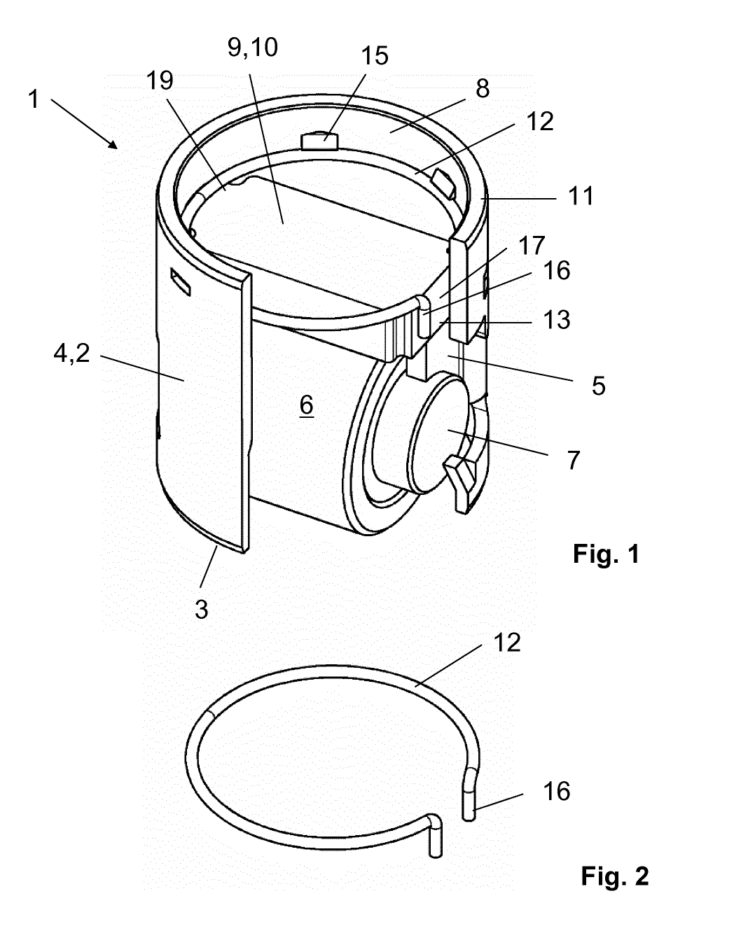

### DETAILED DESCRIPTION OF THE PREFERRED EMBODIMENTS

Shown is a tappet 1, here for a high-pressure fuel pump of an internal combustion engine. The tappet 1 has a tube-like or ring-like housing 2, with two flat sections 5 indented from an outer lateral surface 4 of the housing 2 lying diametrically opposite each other on the drive-side annular end face 3 of this housing. One end of a pin 7 carrying an anti-friction-bearing-supported roller 6 is held in each flat section 5. The roller 6 is used for a run-in of a cam or eccentric or a group of one of these elements.

An inner lateral surface 8 of the housing 2 is passed through axially under the roller 6 by a beam-like and comparatively thick-walled bridge piece 9 whose driven-side end face 10 is used as a contact for a pump piston as a tappet follower.

The beam-like bridge piece 9 is held axially in the direction toward the drive-side annular end face 3 on the chord-like bottom sides 13 of the flat section 5. In the direction toward the opposite driven-side annular end face 11 of the housing 2 there is a securing ring 12 fixed on the inner lateral surface 8, wherein the bridge piece 9 is clamped between the latter and the bottom sides 13 of the flat section 5 without play in the axial direction. Retaining projections 15 that are snap tabs indented from the outer lateral surface 4 of the housing 2 are used to fix the securing ring 12.

As can be seen from FIG. 2, snap ends 16 of the securing ring 12 are bent away in the axial direction in the shape of a hook. They sit in a circular section-like gap 18 between the inner lateral surface 8 of the housing 2 and a flattened section 17 on an end face 20 of the bridge piece 9. Due to the pretensioning of the snap ring 12 acting outward in the radial direction and finally its snap ends 16, a simple radial clamping of the bridge piece 9 is realized.

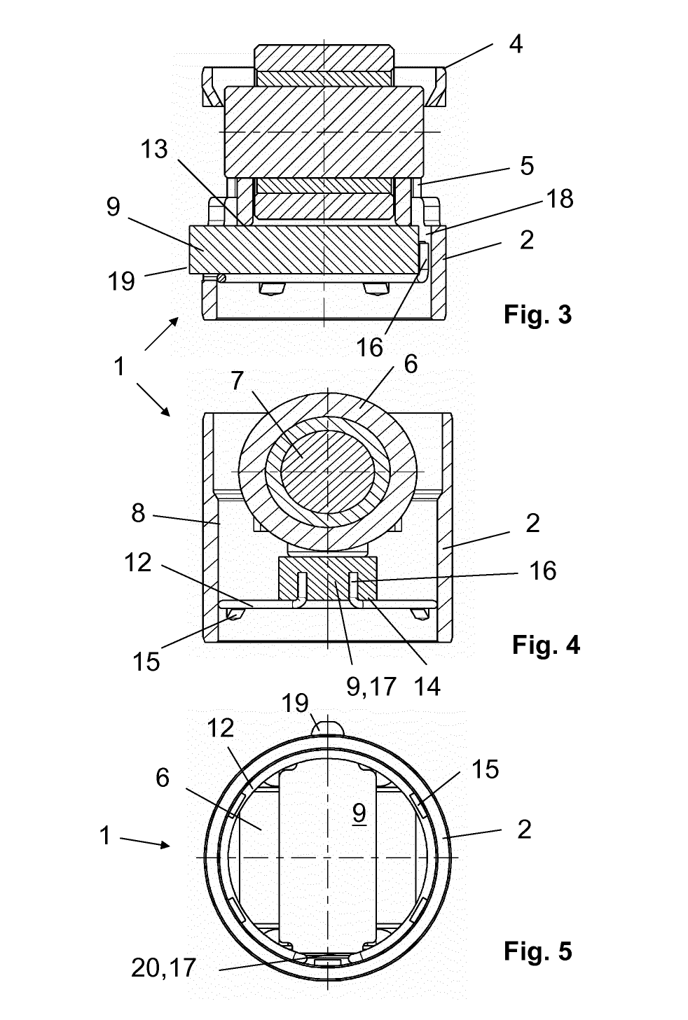

As can be seen in FIGS. 3 and 5, the bridge piece 9 projects on the side of its other end face 19 like a tab through the housing 2, so that, at the same time, a simple rotational locking is given for the tappet 1 relative to its guidance. Thus, separate rotational locking bodies can be eliminated.

In summary, the bridge piece 9 is held clamped in the housing 2 in the axial and radial directions. Rattling noises through an axial movement of the bridge piece 9 no longer occur.

### LIST OF REFERENCE NUMBERS

1) Tappet
2) Housing
3) Drive-side annular end face
4) Outer lateral surface
5) Flat section
6) Roller
7) Pin
8) Inner lateral surface
9) Bridge piece
10) End face
11) Driven-side annular end face
12) Securing ring
13) Bottom side
14) Top side
15) Retaining projection
16) Snap end
17) Flattened section
18) Lens-shaped gap
19) One end face
20) Another end face

1. A tappet for a pump or a compressor, comprising a tube-shaped housing, with two flat sections indented from an outer lateral surface of the housing lying diametrically opposite each other in a drive-side annular end face of said housing, a pin carrying a roller is supported in the flat sections, a separate bridge piece passes through an inner lateral surface of the housing, axially underneath the roller, a driven-side end face of the bridge piece acts as a contact surface for a tappet follower part and is contacted axially on one side in a direction toward the drive-side annular end face on bottom sides of the flat sections and also, on the other side, in a direction toward a driven-side annular end face of the housing by a securing ring fixed on the inner lateral surface, the bridge piece is held clamped in the housing by the securing ring without play in axial and radial directions.

2. The tappet according to claim 1, wherein the bridge piece is clamped between a top side of the securing ring and the bottom sides of the flat section for forming an axial clamping, and the securing ring sits either on retaining projections projecting from the inner lateral surface of the housing or in an annular groove in the inner lateral surface of the housing.

3. The tappet according to claim 1, wherein for forming a radial clamping between the bridge piece and the inner lateral surface of the housing, snap ends of the securing ring are bent in the axial direction of the tappet and have a hook-shaped profile, spreading out away from each other.

4. The tappet according to claim 3, wherein the bridge piece is provided with a chord-shaped flattened section, and snap ends of the securing ring engage in a lens-shaped gap formed between said flattened section and the inner lateral surface of the housing.

5. The tappet according to claim 1, wherein the bridge piece is a beam having one end face that passes through the housing and extends as a tab for forming a tappet rotational locking device.

6. The tappet according to claim 2, wherein the retaining projections are present either a) as extensions/passed-through material going out from the outer lateral surface of the housing, b) as attachments to the inner lateral surface of the housing, or c) as welded or soldered points on the inner lateral surface of the housing.

7. The tappet according to claim 2, wherein the retaining projections are present and formed as snap tabs.
